(19) United States
(12) Patent Application Publication
(10) Pub. No.: US 2007/0115281 A1
(43) Pub. Date: May 24, 2007

(54) Three-dimensional genealogical display system

(76) Inventors: Raymond J. Litzau, Dorsey, IL (US); Hannah R. Litzau, Dorsey, IL (US); Alexander J. Litzau, Dorsey, IL (US)

Correspondence Address: LITMAN LAW OFFICES, LTD., P.O. BOX 15035, CRYSTAL CITY STATION, ARLINGTON, VA, 22215, US

(21) Appl. No.: 11/601,624

(22) Filed: Nov. 20, 2006

Related U.S. Application Data
(60) Provisional application No. 60/738,997, filed on Nov. 23, 2005.

(51) Int. Cl. G06T 15/00

(52) U.S. Cl. 345/419

(57) ABSTRACT

The three-dimensional genealogical display system is a three-dimensional structure, in the shape of a cone or a pyramid, which is divided into vertical tiers, with each tier representing a genealogical generation. Each vertical tier includes a name entry region for each member of the respective generation, allowing the user to print the member's name in the respective name entry region. The three-dimensional genealogical display system may be in the form of a blank, which the user folds and secures to form the three-dimensional structure, or, alternatively, the system may include a plurality of blocks, each having a name entry region formed thereon, which may be stacked together to form the three-dimensional structure.

### CROSS-REFERENCE TO RELATED APPLICATION

This application claims the benefit of U.S. Provisional Patent Application Ser. No. 60/738,997, filed Nov. 23, 2005.

### BACKGROUND OF THE INVENTION

1. Field of the Invention

The present invention relates to display devices, and particularly to a three-dimensional genealogical display system that may be implemented in a printable medium, such as paper, cardboard, or similar media, or in blocks.

2. Description of the Related Art

A wide variety of three-dimensional display systems have been utilized for advertising, general display and record keeping. The record keeping systems, in particular, typically provide some sort of demarcated surface, allowing the user to enter data or information in particular places. Such display systems, however, are not well adapted for the keeping of genealogical records. Although names can be entered into any record keeping system or database, it is helpful for a genealogical system to be divided into generations. It is particularly helpful if the system includes generational divisions dictated by a geometrical progression, i.e., the initially recorded person has one allocated division, the parents of that person have two divisions, the grandparents have four divisions, the great-grandparents have eight divisions, etc. A generalized three-dimensional display system for the entry of general data is not typically divided for the particular needs of genealogical record keeping.

Although genealogical display systems have been used in the past, such systems typically include a two-dimensional branched or tree-like structure, some even simulating actual trees. Such systems, however, present information only in a single plane of view, and do not provide information or ornamental display properties when viewed from any angle, such as would be provided by a three-dimensional display system. Further, it is difficult to enter information into the allotted name entry spaces on a tree-like structure, as the “branches” may be easily bent or damaged. Thus, a three-dimensional genealogical display system solving the aforementioned problems is desired.

### SUMMARY OF THE INVENTION

The three-dimensional genealogical display system is a three-dimensional structure in the shape of a cone or a pyramid, which is divided into vertical tiers, with each tier representing a genealogical generation. Each vertical tier includes a name entry region for each member of the respective generation, allowing the user to print the member's name in the respective name entry region. The number of name entry regions within each vertical tier is based upon a geometrical progression. The user's name appears in the top tier, which provides a single name entry region; the next tier down includes two name entry regions for the user's parents' names; the third tier down includes four name entry regions for the users' grandparents' names, etc. Each name entry region is a demarcated area printed on the outer face of the three-dimensional geometrical structure in which the user may write or print the appropriate names.

The three-dimensional genealogical display system may be in the form of a blank made from paper or similar media, which the user folds and secures to form the three-dimensional structure. The blank is pre-printed with user-selectable indicia and has clearly demarcated name entry regions imprinted thereon for the user to enter the names of the user's family. The blank has first and second side edges, which converge at a vertex, and at least one tab is formed on the first side edge to engage a slot formed on the second side edge. The engagement of the tab with the slot secures the first side edge to the second side edge, thus maintaining the three-dimensional shape.

Alternatively, the system may include a plurality of blocks, each having a name entry region formed thereon, which may be stacked together to form the three-dimensional structure. The top tier is a single block forming the vertex of the cone or pyramid. The lower tiers are formed from wedge-shaped blocks, which are shaped to engage with one another to form the vertical tiers. The middle tiers and the bottom tier each have a recess formed in an upper surface thereof, and the top tier and the middle tiers have projecting members formed on the bottom surfaces thereof. The projecting members fit into the respective recesses in order to secure the blocks together and maintain the three-dimensional shape.

These and other features of the present invention will become readily apparent upon further review of the following specification and drawings.

### BRIEF DESCRIPTION OF THE DRAWINGS

FIG. 1 is a perspective view of a first embodiment of a three-dimensional genealogical display system according to the present invention.

FIG. 2 is a top view of foldable blank used to make the three-dimensional genealogical display system of FIG. 1.

FIG. 3 is a perspective view of a second embodiment of a three-dimensional genealogical display system according to the present invention.

FIG. 4 is a top view of a foldable blank used to make the three-dimensional genealogical display system of FIG. 3.

FIG. 5 is an exploded perspective view of a third embodiment of the three-dimensional genealogical display system of the present invention.

FIG. 6 is an exploded perspective view of the bottom tier of the three-dimensional genealogical display system of FIG. 5, as viewed from above.

FIG. 7 is an exploded perspective view of a middle tier of the three-dimensional genealogical display system of FIG. 5, as viewed from below.

FIG. 8 is an exploded perspective view of a fourth embodiment of the three-dimensional genealogical display system according to the present invention.

FIG. 9 is an exploded perspective view of the bottom tier of the three-dimensional genealogical display system of FIG. 8, as viewed from above.

FIG. 10 is an exploded perspective view of a middle tier of the three-dimensional genealogical display system of FIG. 8, as viewed from below.

Similar reference characters denote corresponding features consistently throughout the attached drawings.

### DETAILED DESCRIPTION OF THE PREFERRED EMBODIMENTS

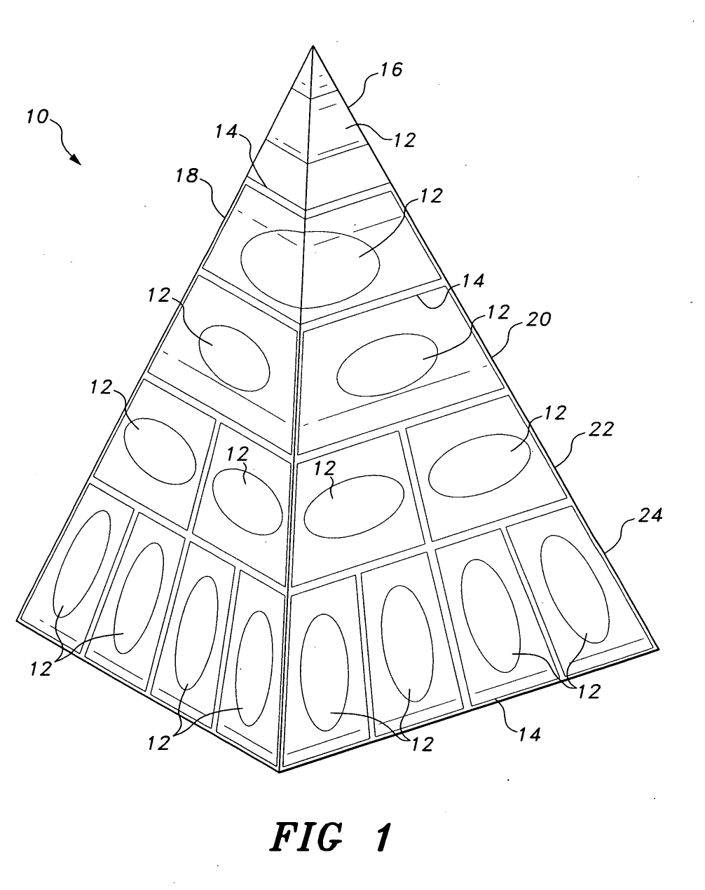

Referring now to FIG. 1, there is shown a first embodiment of a three-dimensional genealogical display system, designated generally as 10 in the drawings. The three-dimensional genealogical display system 10 is shown in FIG. 1 as having a substantially pyramidal shape. However, as will be described in detail below, other three-dimensional shapes may be utilized. The display 10, as shown, is divided into a plurality of descending vertical tiers 16, 18, 20, 22 and 24, with each vertical tier representing a genealogical generation. Each vertical tier 16, 18, 20, 22 and 24 includes one name entry region 12 for each member of the respective genealogical generation. The user may write or otherwise imprint the names of each member of each generation within the name entry regions.

The number of name entry regions 12 for each vertical tier follows a geometric progression. If the user's name is entered in the single name entry region 12 of first tier 16, the names of the user's parents will be entered into the two name entry regions 12 provided in the second tier 18, the names of the user's grandparents will be entered into the four name entry regions 12 provided in the third tier 20, the names of the user's great-grandparents will be entered in the eight name entry regions 12 provided in the fourth tier 22, and the names of the user's great-great-grandparents will be entered in the sixteen name entry regions 12 provided in the fifth tier 24. Although shown as having five tiers, the dimensions and the number of tiers of display 10 are dependent upon the needs and desires of the user. Each name entry region 12 may contain the name of a family member and may further contain any other data the user may wish to enter, such as the birth and death dates of that particular family member.

In addition to the name entry regions 12 imprinted on the outer face of the three-dimensional genealogical display system 10, user-selectable indicia 14 may also be added. For example, a pine needle design representing the “family tree” may be imprinted on the face of the display 10, or a representation of bricks or sandstone may be printed to simulate a pyramid. The user-selectable indicia 14 chosen to ornament display 10 is dependent upon the needs and desires of the user.

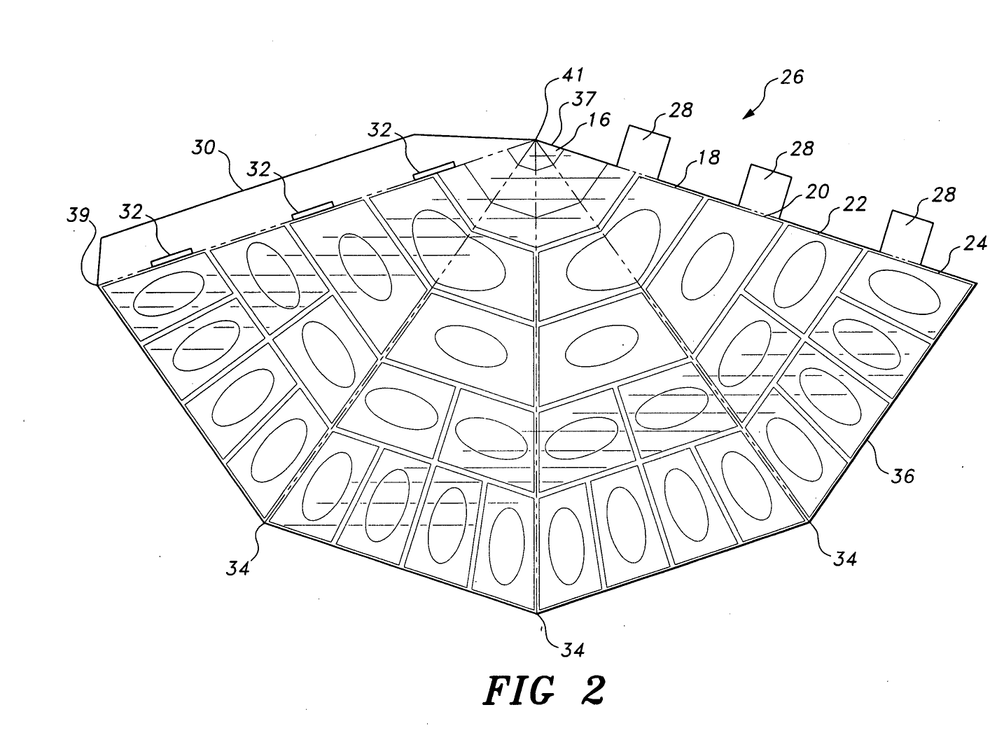

The three-dimensional display system 10 is formed as a blank 26, as shown in FIG. 2, which is then folded into a three-dimensional shape, such as the square-based pyramid shown in FIG. 1. The blank 26 is formed from paper, cardboard, paperboard or similar foldable and printable media, and has indicia 14 and name entry regions 12 imprinted thereon. The blank 26 has a pair of first and second side edges 37, 39, which converge in the vertex 41. First side edge 37 has at least one tab 28 (here shown as three tabs, though the number of tabs used is dependent upon the needs and desires of the user) formed thereon and projecting outwardly therefrom, and second side edge 39 has a connection member 30 formed thereon and projecting outwardly therefrom. Connection member 30 has at least one slot 32 formed therethrough for receiving and engaging the at least one tab 28.

In use, the user enters the names of the user and the user's ancestors into the name entry regions 12 and then folds the blank 26 along fold lines 34 in order to create the three-dimensional shape, such as the pyramid shown in FIG. 1. Tabs 28 are inserted into corresponding slots 32 in order to secure first side edge 37 to second side edge 39 and maintain the display 10 in the desired three-dimensional shape. The lower edge 36 of blank 26 acts as the base of the three-dimensional display, and the vertex 41 of blank 26 becomes the vertex of the three-dimensional shape.

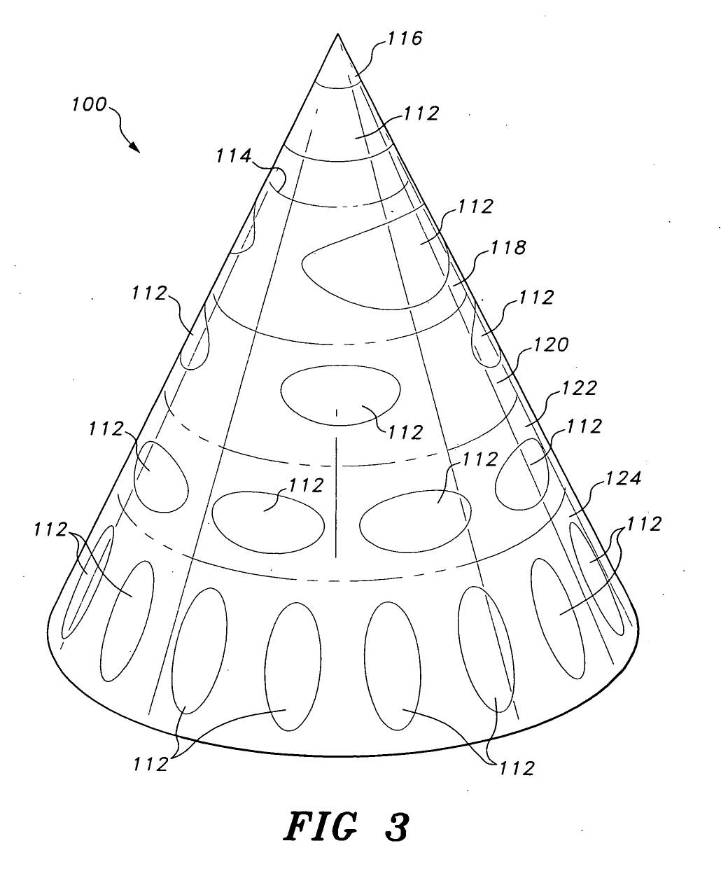

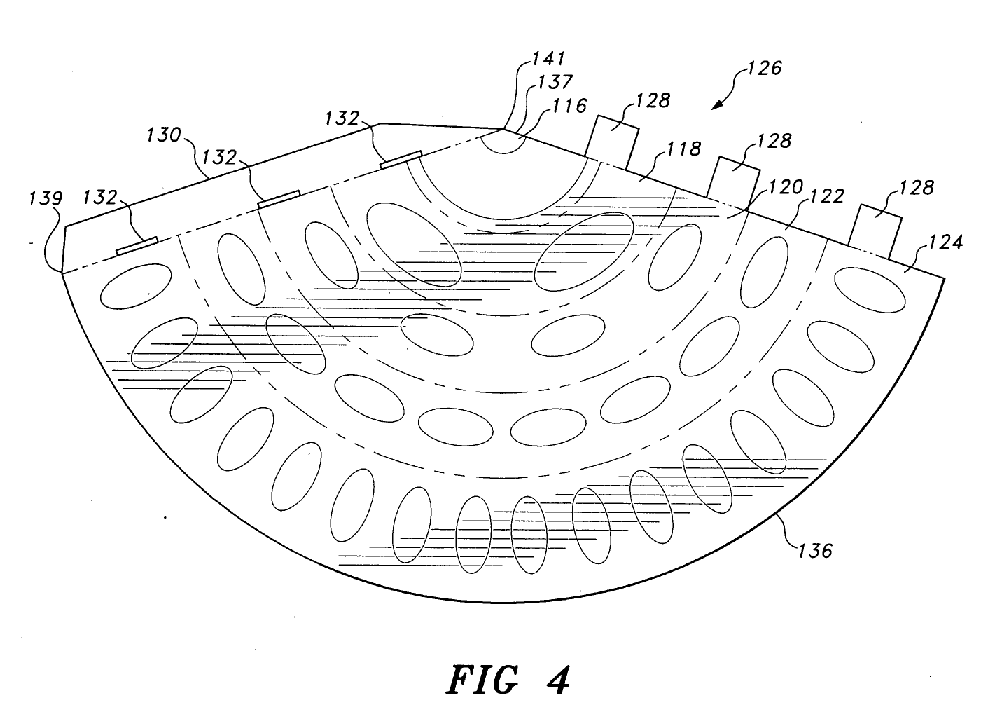

In the alternative embodiment shown in FIGS. 3 and 4, the three-dimensional genealogical display system 100 has the shape of a cone, rather than the pyramid of FIGS. 1 and 2. Similar to the embodiment shown in FIGS. 1 and 2, the display 100 is divided into a plurality of descending vertical tiers 116, 118, 120, 122 and 124, with each vertical tier representing a genealogical generation. Each vertical tier 116, 118, 120, 122 and 124 includes one name entry region 112 for each member of the respective genealogical generation. The user may write or otherwise imprint the names of each member of each generation within the name entry regions. In addition to the name entry regions 112 imprinted on the outer face of the three-dimensional genealogical display system 100, user-selectable indicia 114 may also be added.

Similar to that shown in FIG. 2, the three-dimensional display system 100 is formed as a blank 126, as shown in FIG. 4, which is then rolled into a three-dimensional shape, such as the cone shown in FIG. 3. The blank 126 is formed from paper, cardboard, paperboard or similar foldable and printable media, and has indicia 114 and name entry regions 112 imprinted thereon. The blank 126 has a pair of first and second side edges 137, 139, which converge in vertex 141. First side edge 137 has at least one tab 128 (shown here as three tabs, though the number of tabs used is dependent upon the needs and desires of the user) formed thereon and projecting outwardly therefrom, and second side edge 139 has a connection member 130 formed thereon and projecting outwardly therefrom. Connection member 130 has at least one slot 132 formed therethrough for receiving and engaging the at least one tab 128.

In use, the user enters the names of the user and the user's ancestors into the name entry regions 112 and then rolls the blank 126 to form the three-dimensional shape, such as the cone shown in FIG. 3. It should be noted that, unlike the embodiment of FIG. 2, no fold lines are required to form the cone shape, since the blank 126 is rolled to form a shape having a circular cross-section, rather than folded to form a cross-sectional shape having vertices.

Tabs 128 are inserted into corresponding slots 132 in order to secure first side edge 137 to second side edge 139 and maintain the display 100 in the desired three-dimensional shape. The lower edge 136 has a substantially arcuate contour to act as the base of the conical three-dimensional display 100, and the vertex 141 of blank 126 becomes the vertex of the three-dimensional shape.

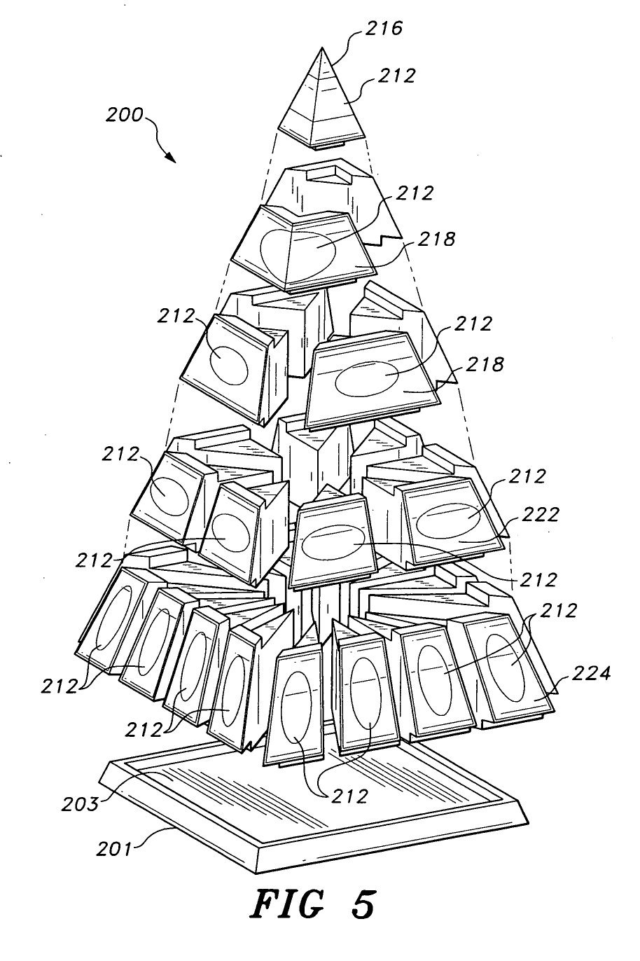

In the alternative embodiment shown in FIGS. 5, 6 and 7, the three-dimensional genealogical display system 200 is formed from a plurality of blocks 226. Similar to the previous embodiments, the display 200, as shown, is divided into a plurality of descending vertical tiers 216, 218, 220, 222 and 224, with each vertical tier representing a genealogical generation. Each vertical tier 216, 218, 220, 222 and 224 includes one name entry region 212 for each member of the respective genealogical generation, as in the previous embodiments. Further, the number of blocks 226 provided for each vertical tier is equal to the number of members in that particular generation, i.e., one block 226 for each member of the genealogical generation is provided. The corresponding name entry region 212 for each member is printed on an outer face of the respective block 226, as shown in FIG. 5. The user may write or otherwise imprint the names of each member of each generation within the name entry regions 212.

Since blocks 226 are three-dimensional elements, the names of generational members may be printed or etched into the name entry regions 212. In addition, the surfaces of blocks 226 may be textured or have indicia, similar to indicia 14 of the previous embodiment, etched into them. For example, the outer faces of blocks 226 may be etched or otherwise formed to resemble pine needles, representing the “family tree”. Alternatively, a brick or sandstone etching may represent the “pyramid” structure. The blocks 226 may be etched or textured in any desired way, depending upon the needs and desires of the user. Further, information may be imprinted or etched on the interior faces of each block. Such information would not be seen when the structure is fully assembled. However, in disassembly, when the user may wish to look at all surfaces of each block, the information would be available on one or more of the interior faces of a block. Such information could include, for example, details about the particular family member, such as occupation, additional marriages, or a listing of other children.

The blocks 226 may be formed from molded plastic, wood, chrome-plated metals, brass-plated metals, gold, silver, crystal or from any other suitable material, depending upon the needs and desires of the user. When crystal or other transparent materials are used in the construction of blocks 226, ancestral names may be etched or otherwise formed in the interior of the block 226, rather than on an exterior face. Alternatively, images, such as, for example, the facial image of the family member, may be etched or otherwise imprinted within the interior of the block 226.

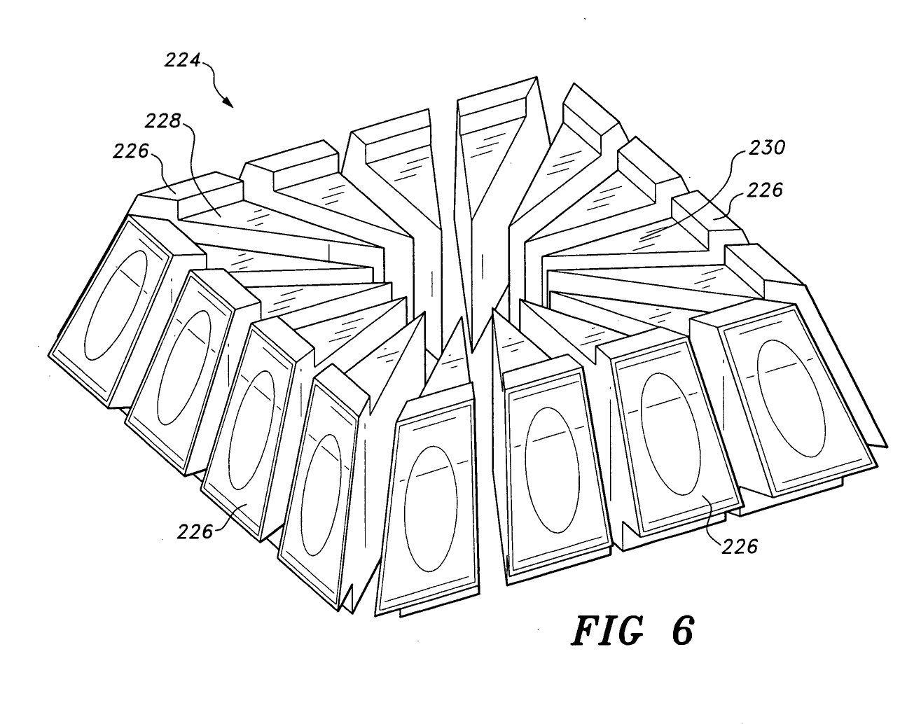

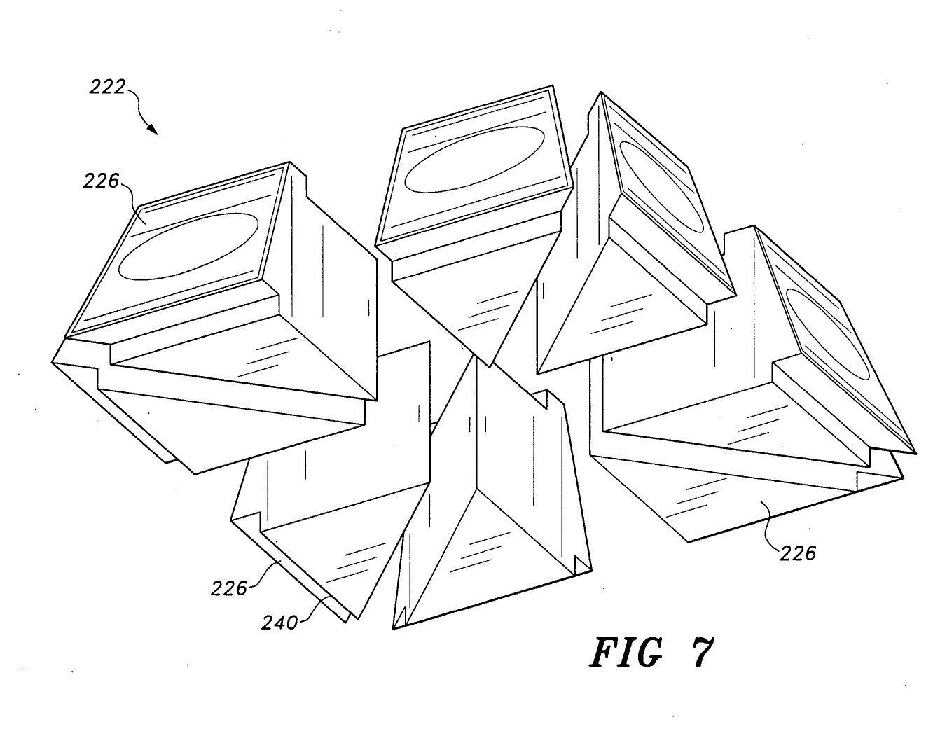

The uppermost block 226 forming first tier 216 is in the form of a pyramid in the pyramidal embodiment of FIG. 5, and the blocks 226 forming the lower tiers, as shown in FIGS. 6 and 7, are wedge-shaped. As best shown in FIG. 6, which represents the bottom-most tier 224, the wedge-shaped blocks 226 join together to form fifth tier 224, having a substantially square-shaped cross-sectional contour. When mated together, as shown, the name entry regions 212 face outward in order to display the genealogical data. In order to secure the blocks 226 together, each block 226 of the lower tiers has a recess 228 formed in an upper surface thereof. When mated together, as shown, the individual recesses 228 form a larger recess 230 having a substantially square shape that spans the upper surface of the tier.

As shown in FIG. 7, the blocks 226 of the upper tiers have corresponding projection members 240 formed on their lower surfaces for engaging the recesses 228. When mated together, the projection members 240 form a square projection having the same dimensions as the recess 230 of the next lower tier. When all of the blocks 226 are mated together, as shown in FIG. 5, to form the three-dimensional construct, the engagement of projection members 240 with engaging recesses 228 secures blocks 226 together to form a secure and solid display system.

Further, the lowermost tier of the structure could alternatively include projection members 240, as shown. These projections would allow the lowermost tier to engage with a separate base 201, which would have a corresponding recess 203, similar to recesses 230, formed therein. The separate base could be a simple plate or other planar structure having a recess 203 formed therein, providing a stable base for the genealogical display structure, with the recess providing support for the blocks of the structure and preventing the foundation from shifting. The base could include indicia or other ornamentation, dependent upon the needs and desires of the user.

In addition, a contoured cover may be provided to protect the three-dimensional display from dust and other sources of contamination or damage. Further, blocks 226 may be produced in a variety of colors, allowing particular ancestors to be highlighted or providing other color-related organization and ornamentation.

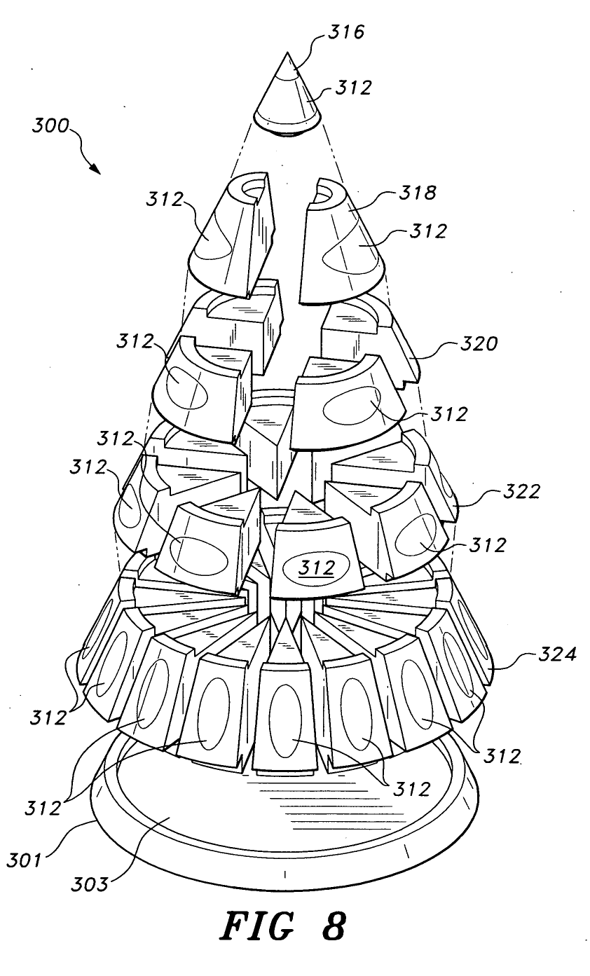

Similar to the embodiment of FIGS. 5, 6 and 7, in the alternative embodiment shown in FIGS. 8, 9 and 10, the three-dimensional genealogical display system 300 is formed from a plurality of blocks 326. Similar to the previous embodiments, the display 300, as shown, is divided into a plurality of descending vertical tiers 316, 318, 320, 322 and 324, with each vertical tier representing a genealogical generation. Each vertical tier 316, 318, 320, 322 and 324 includes one name entry region 312 for each member of the respective genealogical generation, as in the previous embodiments. Further, the number of blocks 326 provided for each vertical tier is equal to the number of members in that particular generation, i.e., one block 326 for each member of the genealogical generation is provided. The corresponding name entry region 312 for each member is printed on an outer face of the respective block 326, as shown in FIG. 8. The user may write or otherwise imprint the names of each member of each generation within the name entry regions 312.

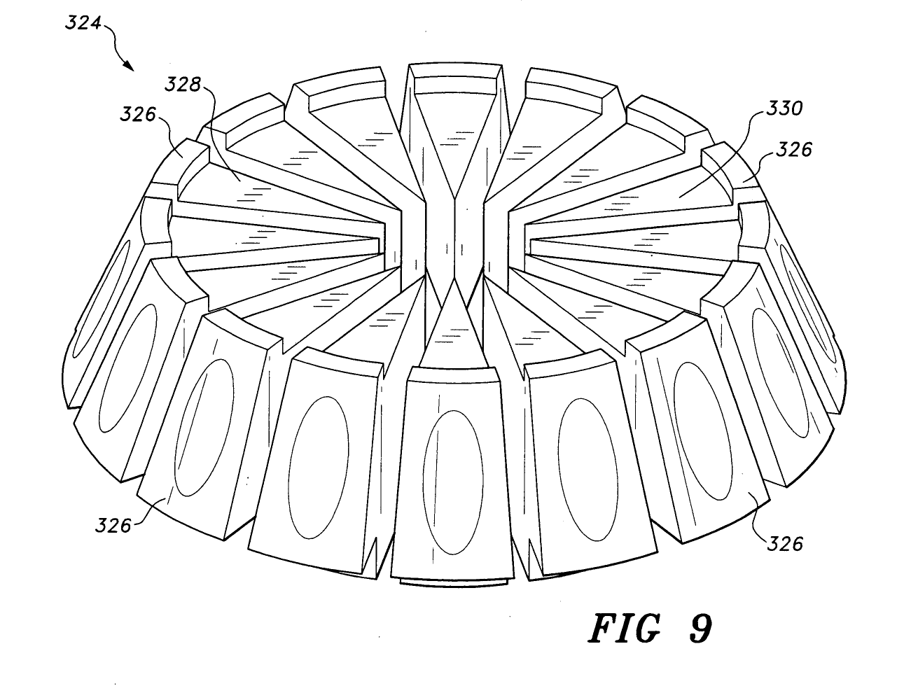

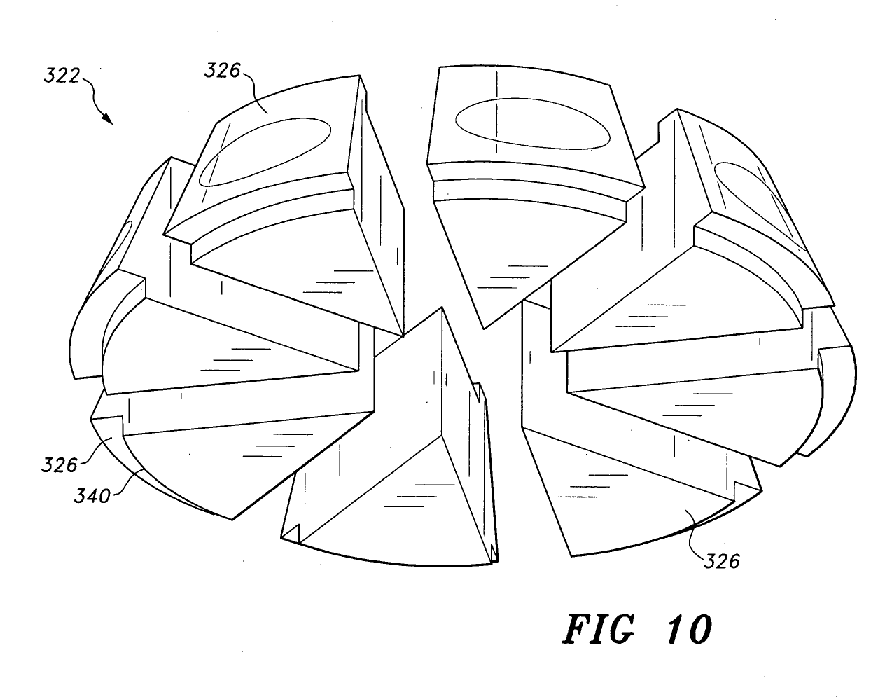

The uppermost block 326, forming first tier 316, is in the form of a cone in the conical embodiment of FIG. 8, and the blocks 326 forming the lower tiers, as shown in FIGS. 9 and 10, are wedge or “pie slice”-shaped. As best shown in FIG. 9, which represents the bottommost tier 324, the wedge-shaped blocks 326 join together to form fifth tier 324, having a substantially circular-shaped cross-sectional contour. When mated together, as shown, the name entry regions 312 face outward to display the genealogical data. In order to secure the blocks 326 together, each block 326 of the lower tiers has a recess 328 formed in an upper surface thereof, similar to that shown in the embodiment of FIG. 6. When mated together, as shown, the individual recesses 328 form a larger recess 330 having a substantially circular-shape spanning the upper surface of the tier.

As shown in FIG. 10, the blocks 326 of the upper tiers have corresponding projection members 340 formed on their lower surfaces for engaging the recesses 328. When mated together, the projection members 340 form a circular projection having the same dimensions of the recess 330 of the next lower tier. When all of the blocks 326 are mated together, as shown in FIG. 8, to form the three-dimensional construct, the engagement of projection members 340 with engaging recesses 328 secures blocks 326 together to form a secure and solid display system. Similar to that shown in FIG. 5, the embodiment of FIG. 8 could further include a base 301 having a substantially circular cross-sectional contour. The base 301 has a circular recess 303 formed in the upper surface thereof to engage projecting members 340 formed on the lower faces of the blocks of the lower-most tier 324.

It is to be understood that the present invention is not limited to the embodiments described above, but encompasses any and all embodiments within the scope of the following claims.

We claim:

1. A three-dimensional genealogical display system, comprising:
a foldable blank having first and second side edges and a lower edge, the first and second side edges converging at a vertex, the foldable blank being divided into a plurality of vertical tiers, each of the tiers representing a genealogical generation and having at least one name entry region for recordation of a name of a member of the genealogical generation;
at least one tab mounted on, and extending from, the first side edge; and
a connection member formed adjacent the second side edge, the connection member having at least one slot formed therethrough corresponding to said at least one tab;
whereby the blank is foldable into a three-dimensional shape secured by engagement of the at least one tab with a corresponding slot, the lower edge of said foldable blank forming a base of the three-dimensional shape.

2. The three-dimensional genealogical display system as recited in claim 1, wherein said foldable blank is adapted for having user-selectable indicia formed thereon.

3. The three-dimensional genealogical display system as recited in claim 1, wherein the three-dimensional shape comprises a pyramid.

4. The three-dimensional genealogical display system as recited in claim 1, wherein the three-dimensional shape comprises a cone.

5. A three-dimensional genealogical display system, comprising:
a plurality of blocks grouped into a top tier, a bottom tier and a plurality of intermediate tiers disposed between the top and bottom tiers, each of the tiers representing a genealogical generation, each of the blocks having a name entry region for recordation of a name of a member of the respective genealogical generation of the block's tier, the top tier consisting of a single one of the blocks, the top tier forming an upper vertex, each of the blocks of the upper tier, the bottom tier and the plurality of intermediate tiers having an upper surface and a lower surface, and each of the blocks of the bottom tier and the plurality of intermediate tiers having a recess formed in the upper surface thereof, each of the blocks of the top tier and the plurality of intermediate tiers having an engagement member projecting downwardly from the lower surface thereof;
wherein the blocks are assembled into a three-dimensional shape with the top tier positioned vertically above the intermediate tiers and the bottom tier being positioned vertically beneath the intermediate tiers, the engagement members engaging the recesses of adjacent intermediate tiers and the bottom tier to secure the blocks in the three-dimensional shape.

6. The three-dimensional genealogical display system as recited in claim 5, wherein the three-dimensional shape comprises a pyramid.

7. The three-dimensional genealogical display system as recited in claim 5, wherein the three-dimensional shape comprises a cone.

8. The three-dimensional genealogical display system as recited in claim 5, further comprising a base having an upper surface and a lower surface, whereby the bottom tier is adapted for mounting on the upper surface of the base, and the lower surface of the base is adapted for mounting on an external support surface.

9. The three-dimensional genealogical display system as recited in claim 8, wherein a base recess is formed in the upper surface of the base.

10. The three-dimensional genealogical display system as recited in claim 9, wherein each of the blocks of the bottom tier further has an engagement member projecting downwardly from the lower surface thereof, the engagement members of the blocks of the bottom tier releasably engaging the base recess of the base.

11. A method of making a three-dimensional genealogical display system, comprising the steps of:
providing a foldable blank having first and second side edges;
dividing said foldable blank into a plurality of vertical tiers;
designating each of the tiers to represent a genealogical generation;
forming a name entry region for each member of the genealogical generation for each of the tiers;
imprinting a name of each of the members in a corresponding one of the name entry regions;
folding the blank into a three-dimensional shape; and
securing the first side edge to the second side edge.

12. The method of making a three-dimensional genealogical display system as recited in claim 11, wherein the step of folding the blank into a three-dimensional shape comprises folding the blank into a pyramid shape.

13. The method of making a three-dimensional genealogical display system as recited in claim 11, wherein the step of folding the blank into a three-dimensional shape comprises folding the blank into a conical shape.
